(19) United States
(12) Patent Application Publication
(10) Pub. No.: US 2026/0203418 A1
(43) Pub. Date: Jul. 16, 2026

(54) Creating a Security-Focused Model Anchored by a Threat Intelligence Table

(71) Applicant: Zscaler, Inc., San Jose, CA (US)

(72) Inventor: Chenhui Hu, Boston, MA (US)

(73) Assignee: Zscaler, Inc., San Jose, CA (US)

(21) Appl. No.: 19/562,335

(22) Filed: Mar. 10, 2026

Related U.S. Application Data
(63) Continuation-in-part of application No. 18/522,769, filed on Nov. 29, 2023.

(30) Foreign Application Priority Data
Oct. 10, 2023 (IN) 202341067875

(51) Int. Cl. G06F 21/57

(52) U.S. Cl. CPC G06F 21/577

(57) ABSTRACT

Systems and methods for enabling cybersecurity inquiries are provided. In one implementation, a method includes a step of receiving cybersecurity threat intelligence data from one or more threat intelligence sources. The method also includes structuring the cybersecurity threat intelligence data into one or more threat intelligence tables each having a plurality of fields describing attributes of network security threats. Also, the method includes sampling rows from each of the one or more threat intelligence tables and programmatically generating, from each corresponding row, a plurality of Q/A/R triples, each Q/A/R triple including a Question element, an Answer element, and a Reasoning element derived from one or more fields. Next, the method includes a step of generating a cybersecurity-focused language model from the one or more threat intelligence tables and the plurality of Q/A/R triples, wherein the cybersecurity-focused language model, when trained, is configured to answer network security inquiries.

### CROSS REFERENCE TO RELATED APPLICATION

The present application is a Continuation in Part (CIP) of U.S. patent application Ser. No. 18/522,769, filed Nov. 29, 2023, and entitled “Systems and methods for utilizing Large Language Models (LLMs) for improving machine learning models in network and computer security,” the contents of which are incorporated by reference herein.

### FIELD OF THE DISCLOSURE

The present disclosure relates generally to networking, computing, and cybersecurity. More particularly, the present disclosure relates to systems and methods for utilizing security threat intelligence grounded in a Large Language Model (LLM) for answering cybersecurity inquiries.

### BACKGROUND OF THE DISCLOSURE

Content classification helps identify and categorize diverse types of data and information on the internet to ensure its appropriate handling, protection, and filtering by various security systems. Identifying and categorizing features associated with content in cloud environments is a long and tedious process. Cloud providers utilize large, dedicated teams for performing content classification and feature extraction. These traditional methods include various steps performed by humans, such as manually reviewing content to determine its nature, context, and potential risks. These methods both cost cloud providers substantial amounts of time, while delaying classification of potentially risky content. Efficient content categorization and classification is crucial for training cloud-based security solutions and protecting both users and devices accessing the internet. In addition to content classification, there are various other use cases for machine learning in network and computer security, such as, for example, malware detection, identifying malicious files for further processing such as in a sandbox, user risk determination, content classification, intrusion detection, phishing detection, application segmentation, and the like.

### BRIEF SUMMARY OF THE DISCLOSURE

The present disclosure provides systems and methods that are configured with at least key features of 1) being anchored to a threat table and 2) having an ability to perform fine-tuning of language models specifically dedicated to answering cybersecurity inquiries. Fine-tuned cybersecurity LLMs can use structured threat tables transformed into anchored Question/Answer/Reasoning (Q/A/R) triples, training the model to generate responses consistent with explicit schema fields rather than unconstrained free text. This approach is especially well-suited for workflows associated with Security Operations Center (SOC) analysts, where correctness, traceability, and reduced hallucination are critical.

In one implementation, a method is disclosed for generating and allowing access to a cybersecurity-based language model or LLM. The method includes a step of receiving cybersecurity threat intelligence data from one or more threat intelligence sources. The method further includes a step of structuring the cybersecurity threat intelligence data into one or more threat intelligence tables each having a plurality of fields describing attributes of network security threats. Also, the method includes a step of sampling rows from each of the one or more threat intelligence tables and programmatically generating, from each corresponding row, a plurality of Q/A/R triples, each Q/A/R triple including a Question element, an Answer element, and a Reasoning element derived from one or more fields. Finally, the method includes a step of generating a cybersecurity-focused language model from the one or more threat intelligence tables and the plurality of Q/A/R triples, wherein the cybersecurity-focused language model, when trained, is configured to answer network security inquiries.

The method may be configured to validate the Q/A/R triples by enforcing field-consistency constraints that verify that the Answer element and Reasoning element are grounded in the fields of the corresponding row. This step of validating the Q/A/R triples may include automatically verifying that the Answer element does not contradict values contained within the corresponding row of the threat intelligence table. Also, the step of validating the Q/A/R triples may further include a step of performing semantic similarity checks using embedding representations to confirm that the Answer element corresponds to allowable schema fields.

The method, according to some implementations, may further include fine-tuning the cybersecurity-focused language model using validated Q/A/R triples to ensure responses are anchored to the fields of the plurality of threat intelligence tables. For instance, the fine-tuning step may be configured to fine-tune the cybersecurity-focused language model by applying Low-Rank Adaptation (LoRA) and/or a parameter-efficient fine-tuning technique.

The network security inquiries described herein may be received from one or more security analysts representing an enterprise having specific cybersecurity concerns. The cybersecurity-focused language model, for example, may be configured to answer each of the network security inquiries by a) selecting one or more rows from one of the threat intelligence tables that are relevant to the respective network security inquiry, and b) generating a response to the network security inquiry that is constrained to information contained within the fields of the selected rows. In some embodiments, the cybersecurity-focused language model may be a Large Language Model (LLM).

The cybersecurity threat intelligence data may include structured or unstructured information (e.g., table based, raw data, etc.) associated with the network security threats. The one or more threat intelligence tables may include threat intelligence derived from one or more of a) Common Vulnerabilities and Exposures (CVE) datasets, b) MITRE ATT&CK datasets, c) cybersecurity kill-chain datasets, and d) enterprise-specific threat intelligence datasets.

The step of structuring the tables may further be configured to normalize the one or more threat intelligence tables according to a predefined schema including one or more of a) an entity type, b) an identifier, c) an attack vector, d) prerequisites, e) impact, f) mitigations, and g) references. Also, the triple generating step may include generating the plurality of Q/A/R triples by producing multiple types of supervised examples derived from individual rows of the one or more threat intelligence tables. The supervised examples, for instance, may include a) direct question-and-answer examples, b) explanation-based questions requiring reasoning derived from schema fields, c) comparative questions involving two rows of the threat intelligence tables, and/or d) counterfactual scenarios based on modification of one or more schema fields.

The method, according to some implementations, may further include inference steps configured to utilize the cybersecurity-focused language model by selecting one or more rows in the one or more threat intelligence tables. Furthermore, the method may include evaluation steps configured to evaluate performance or an evaluation score of the cybersecurity-focused language model using a) a field grounding rate, b) a contradiction rate, c) an abstention correctness metric, and/or d) a comparative fidelity metric. In some embodiments, the method may further include a step of retraining the cybersecurity-focused language model when the evaluation score falls below a predetermined threshold.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a flow diagram of a data streaming service for providing data associated with the cloud-based system

FIG. 2 is a flow diagram of an example for converting tabular data to prompts for creating embeddings therefrom.

FIG. 3 is a graph representing relationships between a plurality of internet ports.

FIG. 4 is a flow chart of a process for utilizing LLMs for network and computer security.

FIG. 5 is a graph of training loss versus training epochs illustrating the results with and without LLM embedding initialization.

FIG. 6 is a diagram illustrating a communication system in which an analyst can obtain answers to cybersecurity inquiries, according to various additional embodiments of the present disclosure.

FIG. 7 is a block diagram illustrating the security inquiry system shown in FIG. 6, according to various embodiments.

FIG. 8 is a block diagram illustrating the training component shown in FIG. 7, according to various embodiments.

FIG. 9 is a block diagram illustrating the interference component shown in FIG. 7, according to various embodiments.

FIG. 10 is a threat intelligence table used for creating a cybersecurity-based LLM, according to various embodiments.

FIG. 11 is a flow diagram illustrating a method for training a cybersecurity-based LLM, according to various embodiments.

FIG. 12 is a flow diagram illustrating a method for using the cybersecurity LLM in an inference or production manner, according to various embodiments.

FIG. 13 is a flow diagram illustrating a method for evaluating the results of using the cybersecurity LLM, according to various embodiments.

FIG. 14 is a flow diagram illustrating a general method for generating a security-based LLM, according to various embodiments.

### DETAILED DESCRIPTION OF THE DISCLOSURE

The present disclosure provides systems and methods for utilizing Large Language Models (LLMs) for improving Machine Learning (ML) and/or Artificial Intelligence (AI) models. More particularly, the LLMs described herein are directed to network and computer cybersecurity. As such, the LLMs herein may be configured, for example, to perform various cybersecurity detection and analysis functions, such as malware detection, identifying malicious files for further processing such as in a sandbox, user risk determination, content classification, intrusion detection, phishing detection, application segmentation, and the like.

### Model Training

Machine learning can be used in various applications in network and computer security, including malware detection, intrusion detection, threat classification, user risk, content risk, detecting malicious clients or bots, application segmentation, etc. In production, a machine learning model is configured to provide some verdict, insight, classification, etc. For example, with malware detection, is a particular file suspect to be benign or malicious; with intrusion detection, is a particular data stream indicative of an intrusion attempt; with classification (e.g., threat, content, URL, etc.), is a particular communication representative of a particular classification; with application segmentation, should a particular user have access to a particular application, etc.

The general process in machine learning includes training where a machine learning model is trained on a dataset, and once trained, the machine learning model is used in production (runtime) to classify unknown content based on the training. That is, the machine learning process includes a training step and a production step. Of course, the dataset is directed towards the particular application. For example, with malware detection, the dataset can include labeled malicious and benign files; with content classification, the dataset can include content with appropriate labels; with application segmentation, the dataset can include users with associated details and their application permissions.

A model training module can be configured to train a machine learning model based on data for modeling. For malware detection, the data for modeling can be selected from a set of benign files and a set of malicious files. Here, the set of benign files includes, for example, a list of files retrieved from one or more third party sources and/or cloud-based system logs. For application segmentation, the data for modeling can be selected from a list of users with details and their associated application permissions.

### Retrieving Tabular Data

The cloud-based system 100 disclosed herein is adapted to collect large amounts of data from various tenants and cloud environments. This data can be in the form of tabular data. The cloud-based system 100 can be configured to consolidate logs from all users, globally, into a central repository that is determined by customers, where administrators can view and mine transaction data by user, device, application, and location in real time.

For organizations that need to transfer their logs to an enterprise Security Information and Event Management (SIEM) system or other location, the cloud-based system 100 provides a service as a virtual machine installed within the customer's network. The service can connect to the cloud-based system and stream out all logs for the tenant to the SIEM or other storage devices in real-time. The protocol used by the service to retrieve logs from the cloud is highly secure and guarantees that the logs cannot be tampered with in transit.

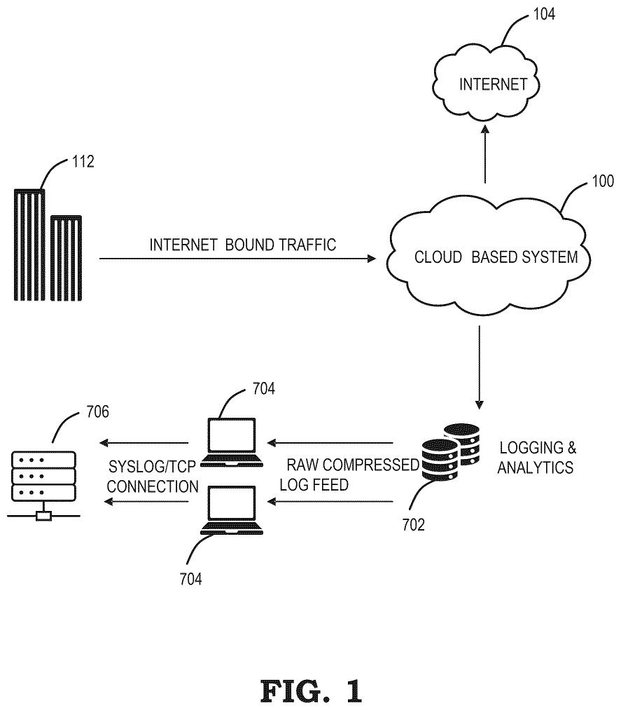

FIG. 1 is a flow diagram of a data streaming service for providing data associated with the cloud-based system 100. As shown in FIG. 1, web and firewall logs are stored in a log 702 in the cloud-based system 100. An organization can deploy the data streaming service instance 704 either on-premises, as an EC2 Instance, or as a Virtual Machine (VM). When an organization deploys an instance of the data streaming service 704 for web and another for firewall logs, each instance is adapted to open a secure tunnel to the log 702 in the cloud-based system 100. The log 702 then streams copies of the logs to each instance of the data streaming service in a highly compressed format to reduce bandwidth footprint. The original logs are retained on the log 702.

When an instance of the data streaming service 704 receives the logs from the log 702, it decompresses and detokenizes them, applies configured filters to exclude unwanted logs, converts the filtered logs to the configured output format so they can be consumed and parsed by the SIEM 706, then streams the logs to the SIEM 706 over a raw TCP connection.

Of note, the data from monitoring in the cloud-based system 100 can relate to various network and computer security applications, i.e., malware detection, intrusion detection, threat classification, the user or content risk, detecting malicious clients or bots, application segmentation, etc. This data can be used as the data for modeling for training a machine learning model for various network and computer security applications.

### Large Language Model

A Large Language Model (LLM) refers to an Artificial Intelligence (AI) system that has been trained on a vast amount of text data and can generate human-like text responses. These models use deep learning techniques, particularly a type of neural network called a transformer, to process and understand the patterns, structure, and semantics of natural language. LLMs are trained on diverse datasets that include a wide range of text sources, such as books, articles, websites, and other written content. During the training process, the model learns to predict the next word or phrase in text based on the patterns it has observed in the training data.

Once trained, these models can be used to generate coherent and contextually relevant responses to prompts or questions. They have a wide range of applications, including natural language understanding, text generation, language translation, chatbots, content creation, and more. LLMs are designed to provide valuable insights, answer questions, engage in conversations, or assist with various language-related tasks.

LLMs are trained on large quantities of unlabeled text, such as the entire internet. Typically, an LLM is trained using self-supervised and/or semi-supervised learning. Unlike other machine learning models which are trained to excel at a specific task, an LLM is trained for a general purpose to perform well at a wide range of tasks. Typically, LLMs are pre-trained via various methods including but not limited to autoregressive and masked pre-training.

In various embodiments described herein, fine tuning a LLM can be utilized for optimizing the LLM for more specific tasks. Fine tuning can include modifying an existing pretrained LLM by training it on a specific task. This can be done in a supervised or unsupervised fashion. This fine tuning can involve an introduction of a new set of weights and causing the model to learn while utilizing the new set of weights during training.

An LLM can be further trained to utilize different tools, that is, an LLM can be trained to call on different programs to provide a desirable output. For example, an LLM can be augmented with document retrieval, typically utilizing a vector database. A document retriever can be called upon by the LLM, given a query, to retrieve relevant documents for generating an output. The LLM can then generate the output based on both the query and the retrieved documents.

Embeddings are a key building block of large language models. LLMs are composed of several key building blocks that enable them to efficiently process and understand natural language data. Embeddings are continuous vector representations of words or tokens that capture their semantic meanings in a high-dimensional space. They allow the model to convert discrete tokens into a format that can be processed by the neural network. In LLMs, embeddings are learned during the training process, and the resulting vector representations can capture complex relationships between words, such as synonyms or analogies.

### Tabular Data Inputs for LLMs

LLMs such as ChatGPT can read and process tabular data. However, it is known that language models primarily excel at understanding and generating human language. While an LLM can handle structured data such as tables, it is important to note that LLMs capabilities are more trained to handle natural language processing rather than traditional data analysis.

An LLM can read the textual contents of cells in tabular data, interpret the context and relationships between the data points, and perform calculations, classifications, and manipulations. LLMs can understand column headers, row values, and even make predictions or recommendations based on the information present in the tabular data. For example, if a table of data is provided to an LLM, questions can be asked about the data, such as, for network data, finding the highest-visited resource, calculating total usage, identifying trends, and categorizing content. The model can read the text in the table and provide relevant responses or perform computations.

In other scenarios, in order to provide tabular data as inputs for an LLM, the tabular data must first be converted to text prompts which the LLM can utilize as an input. As described, large amounts of data are collected via the cloud-based system 100. This data can be in the form of large tabular datasets which are stored in logs. There are various approaches for converting tabular data to natural language which an LLM can utilize. These approaches can include using the LLM to provide predictions on unlabeled tabular data, such as embeddings. For example, one approach includes serializing feature names and values of tabular data into natural language strings. These strings can then be combined with task specific prompts. Output probabilities can be obtained from the LLM which can be used for fine tuning. Once tuning is completed, the tuned LLM can be used to obtain predictions on unlabeled tabular data.

### Utilizing LLM Outputs for Network and Computer Security

The present disclosure provides systems and methods for utilizing Large Language Models (LLMs) for improving training of machine learning models for network and computer security. As described, the cloud-based system 100 collects a vast amount of data associated with users, tenants, organizations, etc. while monitoring. The systems and methods disclosed herein provide techniques for using LLMs with tabular data for providing insights that can be used to support, enhance, and train machine learning models for network and computer security systems such as the various security systems and models disclosed herein.

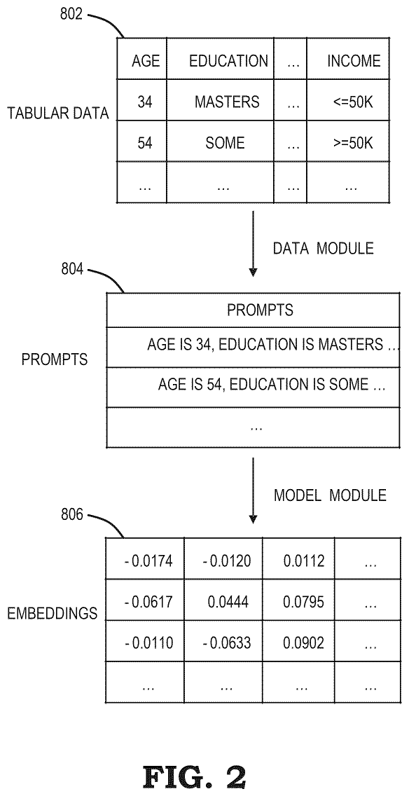

FIG. 2 is a flow diagram of an example for converting tabular data to prompts for creating embeddings therefrom. In an embodiment, the systems and methods include creating text prompts 804 using tabular data 802. These prompts 804 are then used as an input for LLMs, and steps can further include generating embeddings 806 therefrom. The present systems and methods propose applying the LLM embeddings 806 to security specific problems, such as providing the embeddings 806 for use in training a model for the network and computer security systems described herein. Since LLMs already have semantic knowledge about various domains, the generated embeddings 806 are meaningful and can effectively represent a row of tabular data. The generated embeddings 806 can be used for various downstream tasks. For example, when the present approach is demonstrated on a real-world use case of generating features for different applications in an intelligent policy use case, the approach gives good results over traditional methods of generating features. Such features can then be utilized by the security systems to train machine learning models and better enforce the policy.

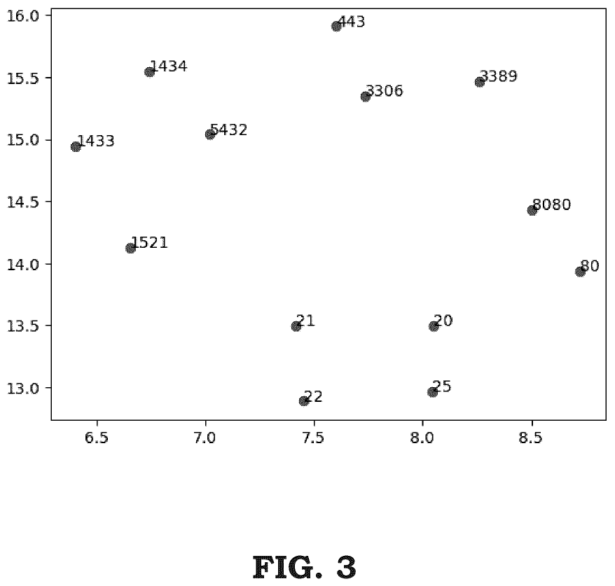

In an exemplary use case, the present systems and methods can be utilized for encoding domain knowledge in internet ports. FIG. 3 is a graph representing relationships between a plurality of internet ports. From the graph of FIG. 3, relationships can be drawn between the various ports. In this example, it can be seen that ports 1433, 1434, 5432, and 1521 are databases and ports 80, 8080, and 443 are HTTPS related. By embedding “internet server TCP port X” more data can be obtained such as which types of users/departments access each port, which can further improve separation/clustering. As described, if more specific domain knowledge is required, the LLM can be fine-tuned.

In various embodiments, an LLM can be utilized to uncover features and categorize content/resources in a cloud-based system. Content can include, but is not limited to, Uniform Resource Locator (URL) content, emails, and any other destination/resource. By utilizing LLMs to classify such content for network and computer security purposes, policy can be enforced more accurately, and models can be trained on more recent data. Traditionally, the content classification process is performed manually, which is time consuming and labor intensive.

In an embodiment, the output of the LLM can include port relationships. These relationships can then be utilized for training a model for use various cloud security systems described herein.

### Process for Utilizing LLMs for Network and Computer Security

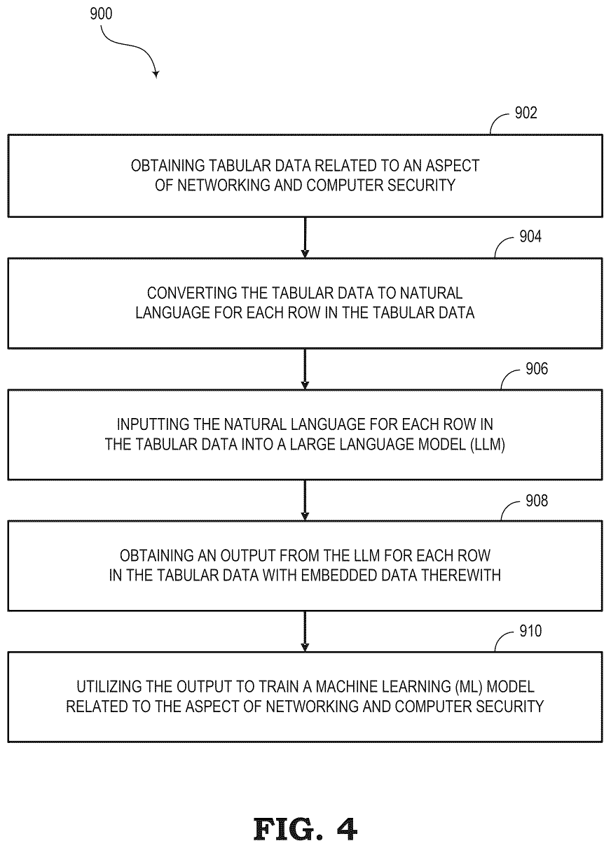

FIG. 4 is a flow chart of a process 900 for utilizing LLMs for network and computer security. The process 900 includes obtaining tabular data related to an aspect of networking and computer security (step 902); converting the tabular data to natural language for each row in the tabular data (step 904); inputting the natural language for each row in the tabular data into a Large Language Model (LLM) (step 906); obtaining an output from the LLM for each row in the tabular data with embedded data therewith (step 908); and utilizing the output to train a machine learning model related to the aspect of networking and computer security (step 910).

The tabular data can be obtained from a cloud-based system, and wherein the tabular data includes data collected based on inline monitoring of users, the Internet, and cloud services. The aspect of networking and computer security can include application segmentation, wherein the tabular data relates to users, data associated with the users, and application permissions for the users. The machine learning model can be trained to determine what applications a new user should have access permissions.

The aspect of networking and computer security can include application segmentation, wherein the tabular data relates to users, identification information for the users, and server ports for applications are used by the users, and wherein the machine learning model is trained to determine which of the applications a new user should have access permissions.

The aspect of networking and computer security can include classifications, wherein the tabular data relates to transactions and associated classifications. The classifications can be for content of an associated Uniform Resource Location (URL).

### Experiments

For illustration, the impact of the approach described here was evaluated on an applied graph clustering problem. In Zscaler ZPA, microsegmentation is one area of zero-trust focusing on application-to-application traffic. There is a need to provide user-to-application policy recommendations for zero-trust. Such policies are needed to reduce the attack surface, but also need to be high quality in terms of the recommendations. Specifically, the policies define what users are allowed to access what applications, i.e., application segmentation.

To produce recommendations, we use a knowledge graph to encode user-app transactions, along with additional metadata about users and applications, for example, which departments/groups the users belong to, or which server ports applications use. We initialized a knowledge graph with the LLM embeddings, and compared the performance to the typical default initialization (e.g., Xavier uniform). We utilized early stopping, with patience=3, and delta=0.001. We compare the performance in various embedding metrics, convergence, and downstream clustering metrics.

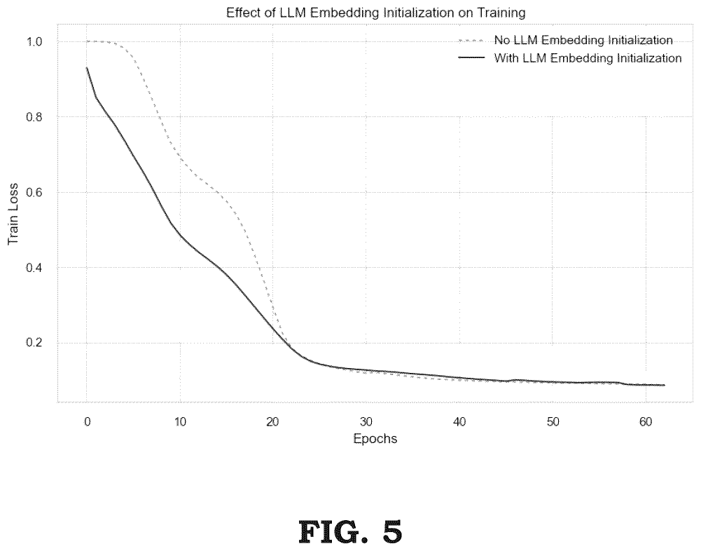

FIG. 5 is a graph of training loss versus training epochs illustrating the results with and without LLM embedding initialization. The plots of training loss indicate a better initial loss, and a quicker “start” to convergence, though notably, the baseline models show faster convergence once it starts. The final loss values and the epoch that they are achieved at are very similar.

The following tables illustrate details associated with various datasets. Using the LLM embeddings, the MAP (Mean Average Precision) at 10, 50, 100 show average improvements of 2.5%, 2.7%, 1.4%, respectively. Similarly, for the MRR (Mean Reciprocal Rank) at 100, the average improvement is 1.3%. We also note that the evaluation relies on a subset of labels, and for those dataset where we have a higher proportion of labels, the scores are higher (datasets A and B).

Again, the embodiments described above may be related to systems and methods for using ML techniques in network and computer security to automate the detection and classification of potentially malicious activity. In typical deployments, ML models can be trained to produce a security-related determination or classification based on observed data. Such determinations can include, for example, identifying whether a file is malicious or benign in malware detection systems, determining whether a network data stream represents an intrusion attempt, classifying URLs or communications according to threat categories, identifying malicious clients or automated bots, or determining appropriate access permissions for users in application segmentation systems. These systems generally rely on models trained using labeled or semi-labeled datasets that capture historical examples of benign and malicious activity.

The ML lifecycle in cybersecurity environments generally includes a training phase followed by a production or runtime phase. During training, a model training module receives datasets that are curated for a particular security task. For example, a malware detection dataset may include labeled malicious and benign files, while datasets for user segmentation or access control may include user identities, organizational metadata, and associated application permissions. Once trained, the model is deployed in a production environment where it processes new, previously unseen data and generates predictions, classifications, or risk assessments based on the patterns learned during training.

These cloud-based security systems may be configured to collect large volumes of operational telemetry that may be used as input data for such machine learning models. These systems typically aggregate logs and transaction data from multiple tenants, devices, applications, and network locations into centralized repositories. The data may be stored in structured formats such as tabular datasets containing event logs, firewall records, web requests, or user-application transactions. In some implementations, the data may be streamed securely to on-premises infrastructure or enterprise Security Information and Event Management (SIEM) systems via dedicated services that retrieve, filter, and transform the logs into formats suitable for downstream analysis. This aggregated telemetry provides a rich source of structured data that can be used for modeling security behaviors and training detection models.

Large Language Models (LLMs) have recently emerged as a class of deep learning models capable of understanding and generating natural language using transformer-based neural network architectures. These models are typically pre-trained on large corpora of textual data using self-supervised learning approaches, such as autoregressive or masked language modeling, enabling them to learn semantic and syntactic relationships between words and concepts. After pretraining, LLMs can be adapted to domain-specific tasks through fine-tuning or through integration with external tools such as document retrieval systems or vector databases. Internally, LLMs rely on embedding representations, which map words or tokens into high-dimensional vector spaces that encode semantic relationships and contextual meaning.

Although LLMs are primarily designed for natural language processing tasks, they can also be applied to structured datasets such as tabular logs by transforming the structured data into textual representations. For example, rows of tabular data containing feature names and values can be serialized into natural language strings or structured prompts. These prompts may then be provided as input to an LLM, which can generate embeddings or other outputs that capture contextual relationships between the data elements. Such embeddings can represent semantic relationships within the data and may be used as feature representations for downstream machine learning tasks.

In cybersecurity applications, embeddings or other outputs generated by LLMs from structured network telemetry may be used to enhance the training of machine learning models that perform security analysis. For instance, tabular data representing network transactions, user behavior, or system events may be converted into textual prompts and processed by an LLM to generate embedding vectors that capture domain knowledge and relationships among features. These embeddings can then be used as input features for security models performing tasks such as threat classification, anomaly detection, application segmentation, or policy recommendation. By incorporating semantic representations learned by the LLM, the resulting models may achieve improved clustering, classification, or prediction performance in network and computer security systems.

The embodiments described below may be configured to build upon the previously discussed implementations. In particular, the following embodiments may be configured to enable assist a Security Analyst, such as a Security Operations Center (SOC) engineer, with respect to answering inquiries specifically focused on cybersecurity issues. That is, the LLMs described below may be specifically trained to answer an analyst query about various aspects of security within an organizational or enterprise domain.

### Security Analyst Assistance System

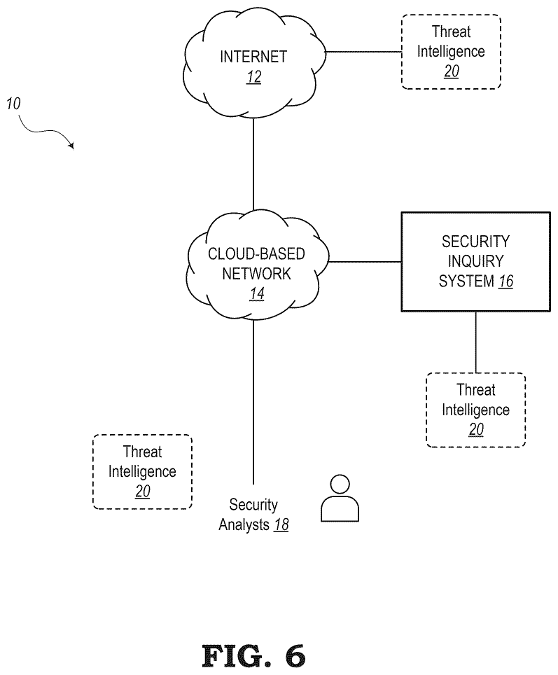

FIG. 6 is a diagram illustrating an embodiment of a security analyst assistance system 10 in which an analyst can obtain answers to cybersecurity inquiries, such as by the help of a cybersecurity-focused LLM. The security analyst assistance system 10 may be configured within or a part of a communications system or network that enables information exchange, searches, data downloads, etc. As shown in the embodiment of FIG. 6, the security analyst assistance system 10 is a communications system allowing online communication over the Internet 12 (or other wide area network). The security analyst assistance system 10 further includes a cloud-based network 14, which, for example, may be configured to offer various cloud-based services (e.g., tools offered by Zscaler). Also, the security analyst assistance system 10 includes a Security inquiry system 16 associated with the cloud-based network 14, which is directed to the key aspects of the present disclosure as defined below.

Furthermore, one or more security analysts 18 (e.g., engineers, network operators, IT professionals, end users, analysts, etc.) may be configured to access the security inquiry system 16 via the cloud-based network 14 to receive assistance with various cybersecurity inquiries. In some embodiments, the security analysts 18 may be associated with an organization, company, enterprise, university, etc. (e.g., employed by or contracted by this entity) for inquiring about cybersecurity information, particularly security concerns for the specific digital infrastructure of that organization

In addition, the security analyst assistance system 10 may include any number of threat intelligence sources 20 arranged throughout the system. For example, threat intelligence may be related to cybersecurity threat (or risk) information that may be organized in any suitable format (e.g., arranged in a table). Threat intelligence sources 20 associated with the Internet 12 may represent publicly available information about known cybersecurity threats. Threat intelligence sources 20 associated with the security inquiry system 16 may represent tables or other templates of public or private, previously disclosed or undisclosed, and common or proprietary cybersecurity threat datasets. Threat intelligence sources 20 associated with the security analysts 18 or corresponding enterprises, for example, may represent privately held information or enterprise-proprietary cybersecurity threats. Proprietary information may be related to specific security issues that may be more prevalent based on unique organizational structures, policies, etc.

### Security Inquiry System

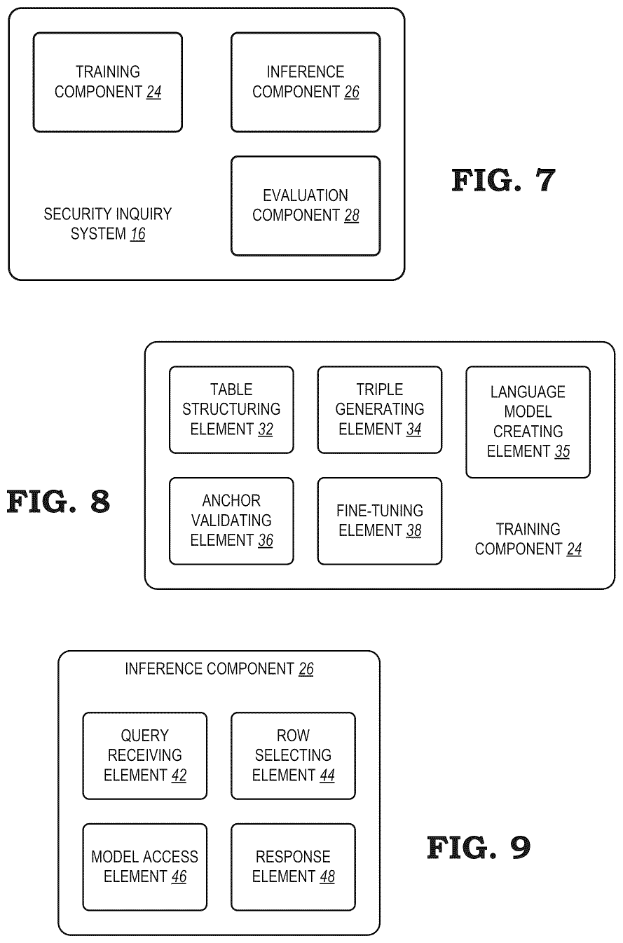

According to various embodiments of the present disclosure, the security analyst assistance system 10 of FIG. 1 includes the security inquiry system 16, which is defined in greater detail with respect to FIGS. 7-9 . The security inquiry system 16 allows a security analyst 18 to inquire about relevant cybersecurity issues and answer these inquiries in a more accurate, fine-tuned manner.

FIG. 7 is a block diagram illustrating an embodiment of the security inquiry system 16. As shown in this embodiment of FIG. 7, the security inquiry system 16 includes a training component 24, an inference component 26, and an evaluation component 28. The training component 24 is configured to train, retrain, and fine-tune a specific LLM (or set of LLMs) to respond accurately to network security issues of concern to the security analysts 18. The inference component 26 is configured to enable runtime use of the cybersecurity-focused LLM. The evaluation component 28 is configured to track various metrics during the training and inference stages to determine the effectiveness of the cybersecurity LLMs.

FIG. 8 is a block diagram illustrating an embodiment of the training component 24 shown in FIG. 7. As shown in this embodiment, the training component 24 includes a table structuring element 32, a triple generating element 34, a language model creating element 35, an anchor validating element 36, and a fine-tuning element 38. Generally, the table structuring element 32 is configured to receive threat intelligence, which in some cases may already be structured in a table format. From this intelligence, the datasets can be normalized and fed into cells within the table.

The triple generating element 34 may generally be configured to create data groups comprising three corresponding parts of security query. For instance, the triples may include 1) a Question element (or query), 2) an Answer element that answers the Question, and 3) a Reasoning element that provides a rationale or explanation of how the Answer was derived. Thus, the triples may be coded as Q/A/R triplets.

The language model creating element 35 is configured to combine the structured table and Q/A/R triples to generate a cybersecurity-focused language model (e.g., LLM). When trained, the cybersecurity-focused language model can be used for performing network security inquiries.

Furthermore, the anchor validating element 36, in general, may be configured to ensure that the information embedded in the security tables is valid, is anchored in truth, and is free of hallucinations. Also, the anchor validating element 36 may verify that the Reasoning elements are ground explanations and are not free-form speculations. The anchor validating element 36 can also automatically check to confirm that the content of the Answer elements is consistent with the fields of the tables.

The training component 24 of the present disclosure introduces two specific techniques during the training stage. A first technique is referred to herein as “Threat-Table-Anchored,” whereby a “threat table” is structured in a way that clearly provides key information that may be used for answering queries about cybersecurity. In particular, the threat tables include cybersecurity threat intelligence (e.g., from threat intelligence sources 20) that clearly define cybersecurity knowledge in an accurate way. Also, this structured table is then used as an anchor or baseline for answering security questions with authority.

A second technique introduced herein is the aspect of “Fine-Tuning,” where the generated cybersecurity threat intelligence tables are fine-tuned to accurately answer queries. Also, any feedback regarding changes to policies can be introduced to the training component 24 to modify weights of the LLM and make other changes as needed to stay up to date with policy modifications. Furthermore, the evaluation component 28 may monitor various metrics throughout the process, whereby the Fine-Tuning may include using these evaluations and measurements to adjust the weights of the LLM.

Thus, the Threat-Table-Anchored, Fine-Tuning (TTA-FT) elements of the present disclosure may be instrumental in improving the reliability and accuracy of cybersecurity-centric LLMs used in network safety and security analyses. The techniques are directed toward fine-tuning a cybersecurity-focused LLM using structured threat intelligence datasets rather than relying primarily on unstructured narrative text. Examples of such structured datasets may include Common Vulnerabilities and Exposures (CVE) metadata tables, MITRE ATT&CK technique matrices, kill-chain stage mappings, and other curated security knowledge tables. Again, these may be obtained from publicly recorded threat intelligence sources 20 or even threat intelligence sources 20 providing proprietary security parameters.

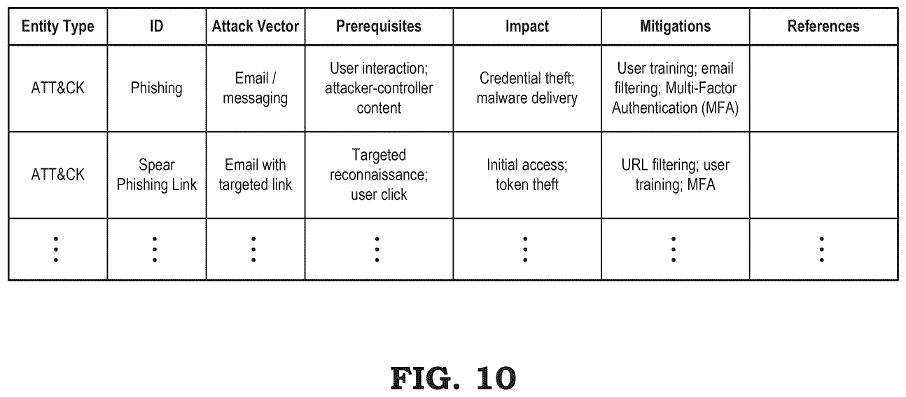

In these embodiments, the table structuring element 32 may be configured to fill the structured tables so that they contain defined schema fields describing attributes of a threat or vulnerability, such as attack vectors, prerequisites, potential impacts, mitigation strategies, and reference information. An example of a structured threat table is shown in FIG. 10. By anchoring model training to these explicit schema fields, the resulting LLM is trained to generate responses that are consistent with authoritative threat intelligence data while reducing the likelihood of unsupported or hallucinated outputs.

The table structuring element 32, in some embodiments, may further be configured to include ingestion and normalization processes in which structured threat intelligence tables are collected from one or more sources and converted into a standardized schema. The normalized schema may include fields such as entity type (e.g., vulnerability, technique, tactic, or campaign), identifier, name, attack vector, prerequisites, impact, mitigations, and references. Once normalized, rows or pairs of rows may be sampled to create training instances. Sampling pairs of rows enables the generation of comparative training questions in which the model must distinguish between related threats or attack techniques.

The sampled rows are then processed by a training data generator that produces the Q/A/R triples and attaches explicit field references that indicate the source attributes used to derive the answer. In some implementations, the triple generating element 34 may be configured to extract information from the structured tables and create “triples” that define a plurality of specific answers to specific questions. Again, the triples are arranged in Question/Answer/Reasoning (Q/A/R) format. In some embodiments, the triples may be stored in a database or other suitable memory that is related to the structured cybersecurity threat intelligence tables. Thus, triple generating element 34 is configured to programmatically transform the rows from the threat intelligence tables into multiple Q/A/R Q/A/R triples used for supervised fine-tuning of the LLM. Each row represents a structured threat entity (e.g., a vulnerability, attack technique, tactic, or campaign) and includes multiple attributes that describe the threat.

During training data generation, a system automatically generates multiple views of each row to produce diverse supervised examples. These examples can include direct question-and-answer pairs for factual retrieval, explanation-based questions that require reasoning grounded in specific schema fields (such as prerequisites or impact), comparative questions involving multiple rows or threat categories, and optionally counterfactual scenarios that explore the effect of modifying certain prerequisites or environmental conditions. The reasoning component of each triple is constrained to information derived from the corresponding table fields so that the generated explanations remain grounded in the underlying structured data.

In some embodiments, the anchor validating element 36 may be configured to enforce field-consistency constraints during training dataset generation and model evaluation. The prompts and target outputs are explicitly tied to allowable schema fields, and validation processes are applied to confirm that generated answers are consistent with the referenced row data. For example, validation rules may ensure that the generated answer only uses information contained in the corresponding row or in explicitly linked rows, does not contradict values in specific fields, and includes citations or field tags identifying the source of the information when required. Such validation may include rule-based checks, semantic similarity checks using embeddings, or evaluation by a secondary language model. By enforcing these constraints, the training data used for fine-tuning remains tightly coupled to authoritative threat intelligence sources, thereby improving model grounding and traceability.

The generated training dataset is then used to fine-tune a base LLM using supervised fine-tuning techniques. In some embodiments, the fine-tuning element 38 may be configured to employ parameter-efficient training methods such as Low-Rank Adaptation (LoRA) or other Parameter-Efficient Fine-Tuning (PEFT) approaches so that the LLM can be adapted without retraining all model parameters. The fine-tuning element 38 is configured to fine-tune the model by training the model to generate answers in a consistent format that remains anchored to the structured fields from which the training examples were derived. In certain implementations, the output format may be structured (e.g., JSON or other machine-readable schema) containing fields such as attack_vector, prerequisites, impact, and mitigations, thereby enabling integration with security orchestration, automation, and response (SOAR) systems or other analyst tools used in security operations centers (SOCs).

FIG. 9 is a block diagram illustrating an embodiment of the inference component 26 shown in FIG. 7. As shown in this embodiment, the inference component 26 includes a query receiving element 42, a row selection element 44, a model access element 46, and a response element 48. Generally, the query receiving element 42 is configured to receive a valid query from a user (e.g., security analyst 18) and apply the query to a relevant cybersecurity-focused LLM that may pertain to the specific enterprise associated with the user. The row selection element 44 is configured to analyze which row (or rows) of the query are pertinent to the answering of the query. The row selection element 44 may also use the Q/A/R triples for uncovering relevant information that can be used for answering the query. The Model access element 46 may then be configured to access the cybersecurity LLM and provide a focused prompt thereto for processing of the prompt. Finally, upon processing of the request via the accessed LLM, the inference component 26 allows the response element 48 to provide a suitable response to the user's question.

At inference time, the row selection element 44 may perform retrieval of relevant threat intelligence rows prior to prompting the fine-tuned model. In such implementations, a retrieval mechanism similar to Retrieval-Augmented Generation (RAG) may be used to identify table rows that are relevant to an analyst query. The retrieved rows are then provided as contextual input to the model, and the fine-tuned model generates an answer using only the permitted fields contained in those rows. Because the model has been trained using table-anchored Q/A/R examples with field-consistency constraints, the generated responses tend to remain tightly aligned with the structured threat intelligence data rather than producing generalized or unsupported recommendations.

In some embodiments, the effectiveness of the approach may be evaluated by the evaluation component 28 by using metrics designed to measure grounding and factual consistency of model outputs. Example evaluation signals may include a) a field grounding rate, b) a contradiction rate, c) an abstention correctness metric, d) a comparative fidelity metric, and other suitable measurements or calculations. The field grounding rate, for example, may be a measurement of the proportion of generated responses whose tokens or semantic content correspond to allowed schema fields. The contradiction rate, for example, may be a detection of inconsistencies between generated responses and the underlying field values. The abstention correctness metric, for example, may be measurement of whether the model appropriately indicates insufficient information when the context does not contain a relevant answer. Also, the comparative fidelity metric, for example, may represent an evaluation of whether comparative responses correctly attribute details to the appropriate threat entities. Through these mechanisms, the Threat-Table-Anchored Fine-Tuning approach improves the reliability, traceability, and analytical usefulness of LLM responses in cybersecurity analyst workflows.

### Threat Intelligence Table

FIG. 10 is an example of a threat intelligence table used for creating a cybersecurity-based LLM. Also, the Q/A/R triples may be derived from each of the rows (or groups of rows) in the threat intelligence table. In this example, the table may include a number of fields (i.e., columns). The fields in this embodiment include a) an “entity type”, b) an “ID,” c) an “attack vector” (or attack surface) to which attacks may be directed, d) “prerequisites” for how an attack may come about, e) “impact” defining the consequences of attacks, f) “mitigations” defining how the attacks can be reduced, and g) “references” defining from whence the threat intelligence was obtained (e.g., threat intelligence sources 20). It may be understood that threat intelligence tables generated according to the teachings of the present disclosure may include different fields and/or fewer or more fields than those shown in FIG. 10.

### Training Method

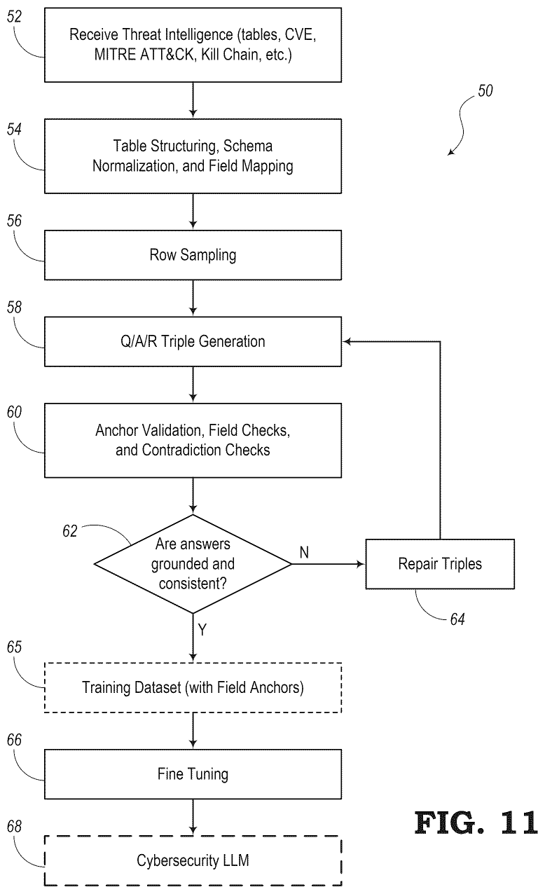

FIG. 11 is a flow diagram illustrating an embodiment of a method 50 for training a cybersecurity-based LLM. In some embodiments, the method 50 may be performed by the training component 24 of the security inquiry system 16. As shown in this embodiment, the method 50 includes a step (block 52) of receiving threat intelligence, which may include information of possible security threats in any format, such as in tables, CVE datasets, MITRE ATT&CK datasets, kill chains, etc. The method 50 also includes a step (block 54) of performing table structuring, schema normalization, and field mapping to properly and uniformly create and fill a useable threat intelligence table that anchors the LLM for properly answering security queries.

Next, the method 50 includes a step (block 56) of performing a row sampling for analyzing the rows in the table. A step (block 58) further includes using these row samplings to generate Q/A/R triples. The method 50 also includes performing anchor validation, field checks, and contradiction checks to determine whether the LLM are properly anchored to reality and are able to provide consistent and reliable information. The method 50 also includes a step (decision block 62) of determining whether the answers are grounded and consistent. If not, the method 50 proceeds to block 64 for repairing the triples appropriated and returning to block 58 for new Q/A/R triple generation and modification and for further validations and checks. If it is determined in decision block 62 that the answers are indeed grounded and consistent, the method 50 is configured to provide a validated training dataset 65 (with field anchors) for proceeding with the training process.

At this point, the method 50 may further be configured to take the validated trained dataset 65 and apply a fine-tuning step (block 66). Again, the fine-tuning may include making adjustments to enable better and more accurate answers. The fine-tuned validated training dataset 65 can then be used for generating a cybersecurity LLM 68 that can be put into production for properly assisting the security analysts 18.

### Inference Method

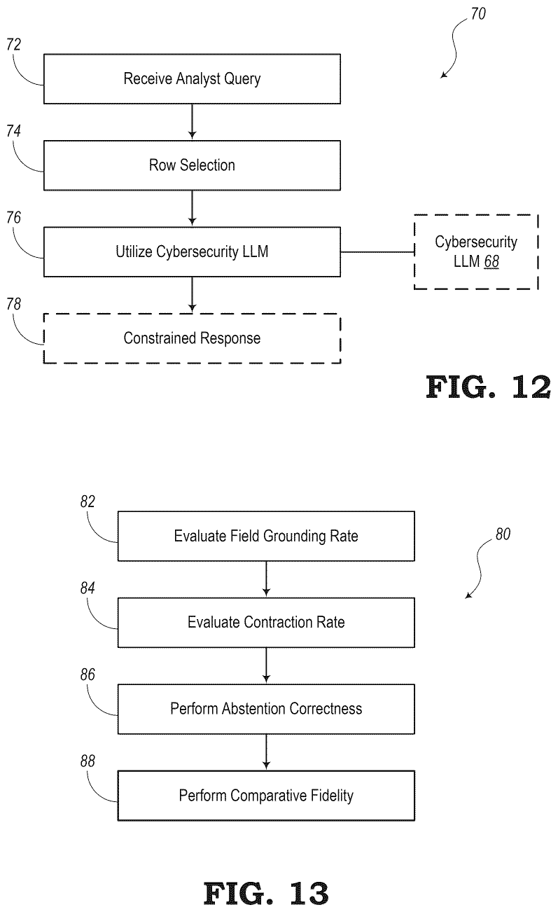

FIG. 12 is a flow diagram illustrating an embodiment of a method 70 for using the cybersecurity LLM during inference or production. In some embodiments, the method 70 may be performed by the inference component 26 of the security inquiry system 16. As shown in this embodiment, the method 70 includes a step (block 72) of receiving an analyst query. The method 70 is configured to analyze this query and perform a row selection step (block 74) for selecting a row of the threat intelligence table that is relevant to the query. The method 70 also includes a step (block 76) of utilizing the cybersecurity LLM (e.g., cybersecurity LLM 68 generated during the training stage). Also, in some embodiments, the method 70 may also include a step (block 78) of providing a constrained response to the query.

### Evaluation Method

FIG. 13 is a flow diagram illustrating an embodiment of a method 80 for evaluating the results of using the cybersecurity LLM. In some embodiments, the method 80 may be performed by the evaluation component 28 of the security inquiry system 16. The method 80 may be performed for obtaining practical evaluation signals that can be used to assess how well the cybersecurity LLM, threat intelligence table, and/or Q/A/R triples are able to accurately respond to network security questions. The method can determine if the answers are based on hallucinations or are indeed grounded (anchored) in reality with accuracy, authority, and precision.

As shown in this embodiment, the method 80 includes a step (block 82) of evaluating a “field grounding rate,” which may be a measure of the percentage of answers whose tokens overlap (or semantically align) with allowed fields. The method 80 also includes a step (block 84) of evaluating a “contradiction rate,” which may be a measure of detected mismatches between answer and field values. This may include rule-based and LLM judge embeddings. The method 80 further includes a step (block 86) of performing an abstention correctness analysis to determine when, if the context lacks an answer, how well the LLM is configured to admit that there is “insufficient information.” Next, the method 80 includes a step (block 88) of performing a comparative fidelity analysis, wherein, for pair of questions, it can be an indication of how well the LLM can correctly ascribe details of the question to the correct table row. In some embodiments, the method 80 may further be configured to combine these evaluation signals to determine an accuracy score, whereby the LLM may be retrained if the score is below a certain threshold.

### Overall Process of Creating and Utilizing Cybersecurity-Focused Language Model

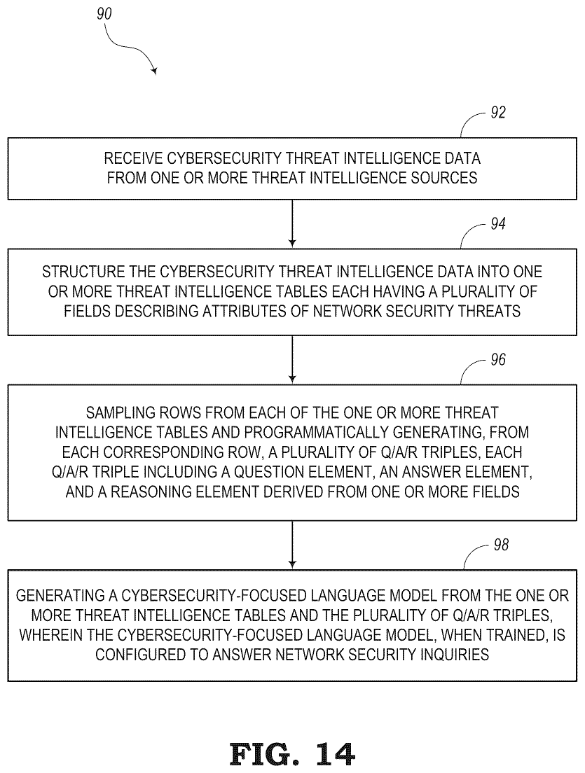

FIG. 14 is a flow diagram illustrating an embodiment of a method 90 for generating and allowing access to a cybersecurity-based language model or LLM. As shown in the embodiment of FIG. 14, the method 90 includes a step (block 92) of receiving cybersecurity threat intelligence data from one or more threat intelligence sources. The method 90 further includes a step (block 94) of structuring the cybersecurity threat intelligence data into one or more threat intelligence tables each having a plurality of fields describing attributes of network security threats. Also, the method 90 includes a step (block 96) of sampling rows from each of the one or more threat intelligence tables and programmatically generating, from each corresponding row, a plurality of Q/A/R triples, each Q/A/R triple including a Question element, an Answer element, and a Reasoning element derived from one or more fields. Finally, the method 90 includes a step (block 98) of generating a cybersecurity-focused language model from the one or more threat intelligence tables and the plurality of Q/A/R triples, wherein the cybersecurity-focused language model, when trained, is configured to answer network security inquiries.

In some embodiments, the method 90 may be executed by the security inquiry system 16 described above with respect to FIGS. 6-9. The method 90 may be configured to validate the Q/A/R triples by enforcing field-consistency constraints that verify that the Answer element and Reasoning element are grounded in the fields of the corresponding row. This step of validating the Q/A/R triples may include automatically verifying that the Answer element does not contradict values contained within the corresponding row of the threat intelligence table. Also, the step of validating the Q/A/R triples may further include a step of performing semantic similarity checks using embedding representations to confirm that the Answer element corresponds to allowable schema fields.

The method 90, according to some implementations, may further include fine-tuning the cybersecurity-focused language model using validated Q/A/R triples to ensure responses are anchored to the fields of the plurality of threat intelligence tables. For instance, the fine-tuning step may be configured to fine-tune the cybersecurity-focused language model by applying Low-Rank Adaptation (LoRA) and/or a parameter-efficient fine-tuning technique.

The network security inquiries described herein may be received from one or more security analysts representing an enterprise having specific cybersecurity concerns. The cybersecurity-focused language model, for example, may be configured to answer each of the network security inquiries by a) selecting one or more rows from one of the threat intelligence tables that are relevant to the respective network security inquiry, and b) generating a response to the network security inquiry that is constrained to information contained within the fields of the selected rows. In some embodiments, the cybersecurity-focused language model may be a Large Language Model (LLM).

The cybersecurity threat intelligence data (block 92) may include structured or unstructured information (e.g., table based, raw data, etc.) associated with the network security threats. The one or more threat intelligence tables may include threat intelligence derived from one or more of a) Common Vulnerabilities and Exposures (CVE) datasets, b) MITRE ATT&CK datasets, c) cybersecurity kill-chain datasets, and d) enterprise-specific threat intelligence datasets.

The step of structuring the tables (block 94) may further be configured to normalize the one or more threat intelligence tables according to a predefined schema including one or more of a) an entity type, b) an identifier, c) an attack vector, d) prerequisites, e) impact, f) mitigations, and g) references. Also, the triple generating step (block 96) may include generating the plurality of Q/A/R triples by producing multiple types of supervised examples derived from individual rows of the one or more threat intelligence tables. The supervised examples, for instance, may include a) direct question-and-answer examples, b) explanation-based questions requiring reasoning derived from schema fields, c) comparative questions involving two rows of the threat intelligence tables, and/or d) counterfactual scenarios based on modification of one or more schema fields.

The method 90, according to some implementations, may further include inference steps configured to utilize the cybersecurity-focused language model by selecting one or more rows in the one or more threat intelligence tables. Furthermore, the method 90 may include evaluation steps configured to evaluate performance or an evaluation score of the cybersecurity-focused language model using a) a field grounding rate, b) a contradiction rate, c) an abstention correctness metric, and/or d) a comparative fidelity metric. In some embodiments, the method 90 may further include a step of retraining the cybersecurity-focused language model when the evaluation score falls below a predetermined threshold.

Thus, the systems and methods herein may be configured with two key features, including 1) using a Threat-Table-Anchored strategy and 2) having the ability for Fine-Tuning. These procedures can fine-tune cybersecurity LLMs using structured threat tables transformed into anchored Q/A/R triples, training the model to generate responses consistent with explicit schema fields rather than unconstrained free text. This approach is especially well-suited to SOC analyst workflows, where correctness, traceability, and reduced hallucination are critical. Also, it may support table-derived semantic field constraints during fine-tuning.

### Examples of Q/A/R Triples

According to an example of a “direct Q&A” type of inquiry, the following Question/Answer/Reasoning (Q/A/R) triples may be created:
Q: “What is the attack vector for ATT&CK T1566 (Phishing)?”
A: “Email or messaging.”
R: “The attack_vector field for T1566 lists Email/messaging.”

According to an example of a “why” question being asked, the following Q/A/R triple may be created:
Q: “Why is user interaction a prerequisite for phishing (T1566)?”
A: “Because phishing requires the user to engage with attacker-controlled content (e.g., open/read/click), which enables credential theft or malware delivery.”
R: “The prerequisites include user interaction and attacker-controlled content; the impact includes credential theft and malware delivery.”

According to an example of a “comparative-type” question received through an inquiry, the following Q/A/R triple may be created:
Q: “Compare phishing (T1566) and spear phishing link (T1566.002) in terms of impact and mitigations.”
A: “Both can lead to credential/token theft and initial access. Spear phishing link emphasizes targeted delivery via a link, so URL filtering is especially relevant; both benefit from user training and MFA.”
R: “Derived from each row's impact and mitigations fields; differences reflect T1566.002's link-focused mitigations.”

Another example of an inquiry at inference time may include an analyst asking, “What mitigations help against spear phishing links?” In response, the system may provide an answer that is tightly aligned to “mitigations” in the table, rather than generic advice.

### Code Generation Implementations

Below are several examples of concrete reference implementations showing 1) how to convert table rows into anchored Q/A/R examples, 2) how to validate grounding, and 3) how to fine-tune with a typical Supervised Fine-Tuning (SFT) setup (e.g., using Low-Rank Adaptation (LoRA), Parameter-Efficient Fine-Tuning (PEFT), and/or other suitable methods). These may be templates that an enterprise may wish to use by plugging in their internal table source data, schema, and preferred base model.

### 1) Data Model+Triple Generation

from __future__ import annotations
from dataclasses import dataclass, asdict
from typing import List, Dict, Any, Tuple
import random
import re
import json
@dataclass
class ThreatRow:
   id: str
   name: str
   attack_vector: str
   prerequisites: str
   impact: str
   mitigations: str
def normalize_text(s: str)->str:
   return re.sub(r“\s+”, “ ”, (s or ″″).strip( ))
def row_to_anchored_context(row: ThreatRow)->str:
   #This is the “grounding payload” the model should rely on.
   #Keeping it compact reduces the chance of the model inventing facts.
   fields={
      “id”: row.id,
      “name”: row.name,
      “attack_vector”: row.attack_vector,
      “prerequisites”: row.prerequisites,
      “impact”: row.impact,
      “mitigations”: row.mitigations
   }
   return json.dumps(fields, ensure_ascii=False)
def make_direct_qa(row: ThreatRow)->Dict[str, Any]:
   q=f“What is the attack vector for {row.id} ({row.name})?”
   a=normalize_text(row.attack_vector)
   r=“Answer derived from the ‘attack_vector’ field.”
   return {“question”: q, “answer”: a, “reasoning”: r, “anchors”: [“attack_vector”]}
def make_why_qa(row: ThreatRow)->Dict[str, Any]:
   q=f“Why are the prerequisites important for {row.id} ({row.name})?”
   a=(
      f“They indicate what conditions must be true for the technique to succeed:”
      f“{normalize_text(row.prerequisites)}. These prerequisites enable outcomes such as ”
      f“{normalize_text(row.impact)}.”
   )
   r=“Answer derived from ‘prerequisites’ and ‘impact’ fields.”
   return {“question”: q, “answer”: a, “reasoning”: r, “anchors”: [“prerequisites”, “impact”]}
def make_mitigation_qa(row: ThreatRow)->Dict[str, Any]:
   q=f“List mitigations for {row.id} ({row.name}).”
   a=normalize_text(row.mitigations)
   r=“Answer derived from the ‘mitigations’ field.”
   return {“question”: q, “answer”: a, “reasoning”: r, “anchors”: [“mitigations”]}
def make_comparative_qa(row_a: ThreatRow, row_b: ThreatRow)->Dict[str, Any]:
   q=(
      f“Compare {row_a.id} ({row_a.name}) vs {row_b.id} ({row_b.name})”
   f“in terms of impact and mitigations.”
   )
   a=(
      f“{row_a.id}: impact={normalize_text(row_a.impact)}; mitigations={normalize_text(row_a.mitigations)}.”
      f“{row_b.id}: impact={normalize_text(row_b.impact)}; mitigations={normalize_text(row_b.mitigations)}.”
   )
   r=“Answer derived from each row's ‘impact’ and ‘mitigations’ fields.”
   return {“question”: q, “answer”: a, “reasoning”: r, “anchors”: [“impact”, “mitigations”], “pair”: [row_a.id, row_b.id]}
def basic_grounding_validator(example: Dict[str, Any], row_ctx_json: str)->Tuple[bool, str]:
   ″″″
   Minimal validator: ensure key phrases in answer appear in context.
      For production: implement stricter checks (field-specific constraints, contradiction detection, etc.).
   ″″″
   ctx=json.loads(row_ctx_json)
   answer=example[“answer”].lower( )
   #Require that at least one anchored field contributes content.
   ok_any=False
   for field in example.get(“anchors”, □):
      field_text=normalize_text(ctx.get(field, ″″)).lower( )
         if field_text and any(tok in answer for tok in field_text.split( )[:5]): #lightweight heuristic
         ok_any=True
         break
   if not ok_any:
      return False, “Answer does not appear grounded in anchored fields (heuristic check failed).”
   return True, “ok”
def generate_dataset(rows: List[ThreatRow], seed: int=7)->List[Dict[str, Any]]:
   random.seed(seed)
   dataset=□
   #Single-row examples
   for row in rows:
      ctx=row_to_anchored_context(row)
      for fn in (make_direct_qa, make_why_qa, make_mitigation_qa):
         ex=fn(row)
         ok, msg=basic_grounding_validator(ex, ctx)
         if ok:
         dataset.append({“context”: ctx, **ex})
         #else: drop or repair; this may drop for simplicity
#Comparative examples (pair sampling)
if len(rows)>=2:
   pairs=random.sample([(a, b) for i, a in enumerate(rows) for b in rows[i+1:]],
      k=min(10, len(rows)*(len(rows)−1)//2))
   for a, b in pairs:
      #For pair, include both contexts
      ctx=json.dumps({“row_a”: json.loads(row_to_anchored_context(a)),
      “row_b”: json.loads(row_to_anchored_context(b))})
      ex=make_comparative_qa(a, b)
      #Skip validator here or implement a pair-aware validator
      dataset.append({“context”: ctx, **ex})
   return dataset
#Example usage
rows=[
   ThreatRow(“T1566”, “Phishing”, “Email/messaging”,
      “User interaction; attacker-controlled content”,
      “Credential theft; malware delivery”,
      “User training; email filtering; MFA”),
   ThreatRow(“T1566.002”, “Spearphishing Link”, “Email with targeted link”,
      “Targeted reconnaissance; user click”,
      “Initial access; token theft”,
      “URL filtering; user training; MFA”)
]
ds=generate_dataset(rows)
print(ds[0])

### 2) Formatting Examples for Supervised Fine-Tuning

A simple, robust pattern can be used to train the model with an instruction that explicitly constrains it:
def to_sft_text(ex: Dict[str, Any])->str:
   #“context” holds the table-derived fields; the model is trained to only use it.
   return (
      “System: You are a cybersecurity assistant. Use ONLY the provided CONTEXT fields.”
      “If the answer is not in the context, say you don't have enough information.\n\n”
      f“CONTEXT:\n{ex[‘context’]}\n\n”

f“User: {ex[‘question’]}\n”

f“Assistant: {ex[‘answer’]}\n”
)

This can be stored as a JSON Lines (JSONL) file with a text field (or messages if an enterprise wishes to use a chat template).

### 3) Fine-Tuning With LoRA (PEFT)

#pip install transformers datasets peft accelerate bitsandbytes (optional)
from datasets import Dataset
from transformers import AutoTokenizer, AutoModelForCausalLM, TrainingArguments, Trainer, DataCollatorForLanguageModeling
from peft import LoraConfig, get_peft_model
BASE_MODEL=“meta-llama/Meta-Llama-3-8B-Instruct” #example; choose your approved base model
#Build dataset
texts=[to_sft_text(ex) for ex in ds]
train_ds=Dataset.from_dict({“text”: texts})
tokenizer=AutoTokenizer.from_pretrained(BASE_MODEL, use_fast=True)
if tokenizer.pad_token is None:
   tokenizer.pad_token =tokenizer.eos_token
def tokenize(batch):
   return tokenizer(batch[“text”], truncation=True, max_length=2048)
train_tok=train_ds.map(tokenize, batched=True, remove_columns=[“text”])
model=AutoModelForCausalLM.from_pretrained(
   BASE_MODEL,
   device_map=“auto”,
   torch_dtype=“auto”
)
#LoRA config (typical starting point; tune as needed)
lora=LoraConfig(
   r=16,
   lora_alpha=32,
   lora_dropout=0.05,
   bias=“none”,
   task_type=“CAUSAL_LM”,
   target_modules=[“q_proj”, “k_proj”, “v_proj”, “o_proj”] #may vary by architecture
)
model=get_peft_model(model, lora)
args=TrainingArguments(
   output_dir=“./tta_ft_lora”,
   per_device_train_batch_size=2,
   gradient_accumulation_steps=8,
   learning_rate=2e−4,
   num_train_epochs=1,
   logging_steps=10,
   save_steps=200,
   fp16=True,
   report_to=“none”
)
collator=DataCollatorForLanguageModeling(tokenizer=tokenizer, mlm=False)
trainer=Trainer(
   model=model,
   args=args,
   train_dataset=train_tok,
   data_collator=collator
)
trainer.train( )
model.save_pretrained(“./tta_ft_lora/final”)
tokenizer.save_pretrained(“./tta_ft_lora/final”)

### Conclusion

It will be appreciated that some embodiments described herein may include one or more generic or specialized processors (“one or more processors”) such as microprocessors; Central Processing Units (CPUs); Digital Signal Processors (DSPs): customized processors such as Network Processors (NPs) or Network Processing Units (NPUs), Graphics Processing Units (GPUs), or the like; Field Programmable Gate Arrays (FPGAs); and the like along with unique stored program instructions (including both software and firmware) for control thereof to implement, in conjunction with certain non-processor circuits, some, most, or all of the functions of the methods and/or systems described herein. Alternatively, some or all functions may be implemented by a state machine that has no stored program instructions, or in one or more Application Specific Integrated Circuits (ASICs), in which each function or some combinations of certain of the functions are implemented as custom logic or circuitry. Of course, a combination of the aforementioned approaches may be used. For some of the embodiments described herein, a corresponding device such as hardware, software, firmware, and a combination thereof can be referred to as “circuitry configured or adapted to,” “logic configured or adapted to,” etc. perform a set of operations, steps, methods, processes, algorithms, functions, techniques, etc. as described herein for the various embodiments.

Moreover, some embodiments may include a non-transitory computer-readable storage medium having computer readable code stored thereon for programming a computer, server, appliance, device, processor, circuit, etc. each of which may include a processor to perform functions as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), Flash memory, and the like. When stored in the non-transitory computer readable medium, software can include instructions executable by a processor or device (e.g., any type of programmable circuitry or logic) that, in response to such execution, cause a processor or the device to perform a set of operations, steps, methods, processes, algorithms, functions, techniques, etc. as described herein for the various embodiments.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims. The foregoing sections include headers for various embodiments and those skilled in the art will appreciate these various embodiments may be used in combination with one another as well as individually.

What is claimed is:

1. A security inquiry system comprising:
a table structuring element that, upon receiving cybersecurity threat intelligence data from one or more threat intelligence sources, is configured to structure the cybersecurity threat intelligence data into one or more threat intelligence tables each having a plurality of fields describing attributes of network security threats;
a triple generating element configured to sample rows from each of the one or more threat intelligence tables and programmatically generating, from each corresponding row, a plurality of Q/A/R triples, each Q/A/R triple including a Question element, an Answer element, and a Reasoning element derived from one or more fields; and
a language model creating element configured to generate a cybersecurity-focused language model from the one or more threat intelligence tables and the plurality of Q/A/R triples, wherein the cybersecurity-focused language model, when trained, is configured to answer network security inquiries.

2. The security inquiry system of claim 1, further comprising an anchor validating element configured to validate the plurality of Q/A/R triples by enforcing field-consistency constraints that verify that the Answer element and Reasoning element are grounded in the fields of a corresponding row.

3. The security inquiry system of claim 2, wherein validating the plurality of Q/A/R triples includes automatically verifying that the Answer element does not contradict values contained within the corresponding row of the one or more threat intelligence tables.

4. The security inquiry system of claim 2, wherein validating the plurality of Q/A/R triples further includes performing semantic similarity checks using embedding representations to confirm that the Answer element corresponds to allowable schema fields.

5. The security inquiry system of claim 1, further comprising a fine-tuning element configured to fine-tune the cybersecurity-focused language model using validated Q/A/R triples to ensure responses are anchored to the fields of the one or more threat intelligence tables.

6. The security inquiry system of claim 5, wherein the fine-tuning element is further configured to fine-tune the cybersecurity-focused language model by applying Low-Rank Adaptation (LoRA) and/or a parameter-efficient fine-tuning technique.

7. The security inquiry system of claim 1, wherein the network security inquiries are received from one or more security analysts representing an enterprise having specific cybersecurity concerns.

8. The security inquiry system of claim 1, wherein the cybersecurity-focused language model is configured to answer each of the network security inquiries by:
selecting one or more rows from one of the one or more threat intelligence tables that are relevant to a respective network security inquiry; and
generating a response to the network security inquiry that is constrained to information contained within the fields of the selected rows.

9. The security inquiry system of claim 1, wherein the cybersecurity-focused language model is a Large Language Model (LLM).

10. The security inquiry system of claim 1, wherein the cybersecurity threat intelligence data includes structured or unstructured information associated with the network security threats.

11. The security inquiry system of claim 1, wherein the one or more threat intelligence tables include threat intelligence derived from one or more of a) Common Vulnerabilities and Exposures (CVE) datasets, b) MITRE ATT&CK datasets, c) cybersecurity kill-chain datasets, and d) enterprise-specific threat intelligence datasets.

12. The security inquiry system of claim 1, wherein the table structuring element is further configured to normalize the one or more threat intelligence tables according to a predefined schema including one or more of a) an entity type, b) an identifier, c) an attack vector, d) prerequisites, e) impact, f) mitigations, and g) references.

13. The security inquiry system of claim 1, wherein the triple generating element generates the plurality of Q/A/R triples by producing multiple types of supervised examples derived from individual rows of the one or more threat intelligence tables.

14. The security inquiry system of claim 13, wherein the supervised examples include one or more of a) direct question-and-answer examples, b) explanation-based questions requiring reasoning derived from schema fields, c) comparative questions involving two rows of the one or more threat intelligence tables, and d) counterfactual scenarios based on modification of one or more schema fields.

15. The security inquiry system of claim 1, further comprising an inference component configured to utilize the cybersecurity-focused language model by selecting one or more rows in the one or more threat intelligence tables.

16. The security inquiry system of claim 1, further comprising an evaluation component configured to evaluate performance or an evaluation score of the cybersecurity-focused language model using one or more of a) a field grounding rate, b) a contradiction rate, c) an abstention correctness metric, and d) a comparative fidelity metric.

17. The security inquiry system of claim 16, wherein the language model creating element is further configured to retrain the cybersecurity-focused language model when the evaluation score falls below a predetermined threshold.

18. A method comprising steps of:
receiving cybersecurity threat intelligence data from one or more threat intelligence sources;
structuring the cybersecurity threat intelligence data into one or more threat intelligence tables each having a plurality of fields describing attributes of network security threats;
sampling rows from each of the one or more threat intelligence tables and programmatically generating, from each corresponding row, a plurality of Q/A/R triples, each Q/A/R triple including a Question element, an Answer element, and a Reasoning element derived from one or more fields; and
generating a cybersecurity-focused language model from the one or more threat intelligence tables and the plurality of Q/A/R triples, wherein the cybersecurity-focused language model, when trained, is configured to answer network security inquiries.

19. The method of claim 18, further comprising a step of validating the plurality of Q/A/R triples by enforcing field-consistency constraints that verify that:
a) the Answer element and Reasoning element are grounded in the fields of a corresponding row;
b) the Answer element does not contradict values contained within a corresponding row of one of the one or more threat intelligence tables; and
c) the Answer element corresponds to allowable schema fields.

20. The method of claim 18, further comprising a step of fine-tuning the cybersecurity-focused language model using validated Q/A/R triples to ensure responses are anchored to the fields of the one or more threat intelligence tables by applying Low-Rank Adaptation (LoRA) and/or a parameter-efficient fine-tuning technique.
